(19) United States
(12) Patent Application Publication
(10) Pub. No.: US 2025/0060013 A1
(43) Pub. Date: Feb. 20, 2025

(54) ELECTROMECHANICAL SERVICE BRAKE, UNLOCKING TOOL AND AN ASSEMBLY

(71) Applicant: ZF Active Safety GmbH, Koblenz (DE)

(72) Inventor: Volker Knop, Ulmen (DE)

(21) Appl. No.: 18/806,027

(22) Filed: Aug. 15, 2024

(30) Foreign Application Priority Data
Aug. 16, 2023 (DE) 102023121907.3

(51) Int. Cl. F16D 65/00; B60T 13/74; F16D 63/00; F16D 121/20; F16D 121/24; F16D 127/06; F16D 131/00

(52) U.S. Cl. CPC F16D 65/0043; B60T 13/746; F16D 63/006; F16D 2121/20; F16D 2121/24; F16D 2127/06; F16D 2131/00

(57) ABSTRACT

An electromechanical service brake having an integrated electrical parking brake and comprising an electric motor and a control unit is presented. The parking brake has a blocking element which, in an arrested state of the parking brake, mechanically blocks a transmission of the electromechanical service brake. The electric motor and the transmission are surrounded by a housing which has a cutout that allows the blocking element to be manually actuated from the outside, such that the blocking element can, from the outside, be mechanically transferred from the arrested state into an opened state. In the opened state, the transmission is freely movable. The cutout is a non-circular formation that has at least one axially running guide groove and/or at least one axially running guide rib. Also presented are an unlocking tool and an assembly comprising the electromechanical service brake and the unlocking tool.

### CROSS-REFERENCE TO RELATED APPLICATIONS

This application claims priority to German Application No. 102023121907.3, filed on Aug. 16, 2023, the disclosure of which is incorporated herein by reference in its entirety.

### TECHNICAL FIELD

The disclosure relates to an electromechanical service brake having an integrated electrical parking brake, having an electric motor, and having a control unit. The disclosure furthermore relates to an unlocking tool for manually unlocking a blocking element of the electrical parking brake, and to an assembly that comprises the electromechanical service brake and the unlocking tool.

### BACKGROUND

Electromechanical service brakes having integrated electrical parking brakes are already known from the prior art. Faults can however occur in the electronics, with the result that the parking brake cannot be released and onward travel is prevented. Such a fault is caused for example by a defective solenoid, a defective motor, a defective control unit or an electrical failure.

The problem lies in the fact that, before the electrical parking brake is opened, the electromechanical service brake must build up a certain tension force in order to release the electrical parking brake. However, if the flow of current is prevented, this is not possible, and the parking brake cannot be released. In such a situation, it is presently necessary for the entire electrical control unit to be detached from the electromechanical service brake, or for the vehicle to be towed in order to enable it to be repaired at a workshop. This is very expensive for the vehicle owner.

What is needed is an electromechanical service brake having an integrated electrical parking brake, in the case of which onward travel, at least to the nearest workshop, is made possible in the event of a blockage of the parking brake.

### SUMMARY

An electromechanical service brake having an integrated electrical parking brake and comprising an electric motor and a control unit is disclosed herein, wherein the parking brake comprises a blocking element which, in an arrested state of the parking brake, mechanically blocks a transmission of the electromechanical service brake. Here, the electric motor and the transmission are surrounded by a housing which has a cutout which allows the blocking element to be manually actuated from the outside, such that the blocking element can, from the outside, be mechanically transferred from the arrested state into an opened state. In the opened state, the transmission is freely movable. The cutout is a non-circular formation that has at least one axially running guide groove and/or at least one axially running guide rib. In other words, the cutout allows access to the blocking element and thus a mechanical transfer from the arrested state into the opened state by manual actuation of the blocking element. The problem of a blocked parking brake can thus be quickly, easily and inexpensively resolved without the need for the vehicle to be towed.

For example, the cutout allows access, from the outside, using a tool that is provided for actuating the blocking element. The underlying concept is accordingly that of allowing manual actuation of the blocking element in a technical emergency, by virtue of a cutout being provided in the housing of the electromechanical service brake.

The at least one axially running guide groove and/or the at least one axially running guide rib are guide aids that simultaneously serve as a precautionary safety measure. These guide aids ensure that the tool can be inserted only in one particular direction and also that only one particular tool can be used, which tool also engages exactly in the optimum location for unlocking the blocking element.

The housing furthermore has an end wall and a side wall, wherein the side wall may have the cutout. The cutout is thus oriented orthogonally with respect to the armature and with respect to the motor shaft and arranged symmetrically over an actuator plunger of the parking brake.

Because a circuit board is arranged directly under and adjacent to the end wall, frontal access to the electrical parking brake is not possible, and therefore the cutout does not simply constitute the opening of a housing cover or of the end wall. The cutout is merely a small opening in the side wall, such that it is difficult or even impossible to access the blocking element without a tool. The cutout, arranged on the side wall, is nevertheless easily accessible, thus allowing the blocking element to be released.

In one exemplary arrangement, the cutout tapers conically and is surrounded by a sleeve-like projection which is formed integrally on the housing and which protrudes outwards. For example, the guide aids are integrated into the projection, wherein the projection simultaneously serves for protecting the cutout and the electrical parking brake.

In one exemplary arrangement, the cutout is covered by a cover, in particular a mushroom-shaped cover. The cover is received in the cutout and in the projection, such that an opening tool is required to remove the cover.

For this purpose, the projection has at least one slot via which the opening tool can engage laterally on the cover in order to remove the cover. The cover serves for protecting the electric motor and the transmission, and also prevents undesired direct access to the blocking element.

Since an opening tool is required to remove the cover, incidental or unauthorized access is consequently prevented, which protects against theft.

The opening tool may be a special tool that is available exclusively to breakdown services, towing services and workshops. It can thus be ensured that the parking brake can be released only by selected persons or services.

Alternatively, the opening tool may be a flat-headed screwdriver that is inserted into the slot in the projection such that the cover can be pried open. It is also conceivable for the cover to be provided with a security lock.

In order to achieve a higher protection rating with regard to leak-tightness, a seal element may be provided between the housing and the cover, which seal element is clamped between the conical region of the cutout and the cover. The seal element includes an elastomer, and is preloaded in its installed state. The seal element thus seals primarily against the conical shoulder.

In one exemplary arrangement, the cover is a pressure-equalizing element between the interior of the housing and the surroundings. For this purpose, a diaphragm is integrated into the cover. The diaphragm is provided for preventing an ingress of liquids and/or dirt and nevertheless allowing air and/or pressure equalization. For this purpose, the diaphragm preferably consists of an expanded polytetrafluoroethylene (ePTFE), which has a microporous structure and hydrophobic and/or oleophobic properties. By virtue of the fact that the cover can serve as a pressure-equalizing element, the number of parts required is reduced, which in turn lowers costs.

The cover may have detent hooks that engage behind the narrowest point of the cutout. Reversible fastening of the cover to the cutout is thus ensured. The cover may however alternatively also be screwed to the housing. With such a screw connection, the slots in the projection are not imperatively required.

In one exemplary arrangement, an electromagnetic actuator, for example a bistable solenoid, is provided for moving the blocking element into the arrested state and the opened state. During normal operation, the electromagnetic actuator is responsible for actuating the parking brake and providing the tension force for releasing the parking brake. The cutout thus serves merely for the transfer of the blocking element into the released state in the event of an electrical fault of the electromechanical service brake.

A bistable solenoid is suitable as an electromagnetic actuator because the armature of the solenoid assumes a stable position only in the fully deployed or the fully retracted extreme setting. Here, a stable intermediate position of the armature is ruled out because the magnetic forces determine the stroke position and therefore move the armature and immobilize it when the electromagnetic actuator is not electrically energized.

The electromagnetic actuator of the parking brake preferably has a load-free connection to the transmission. This load-free connection enables the actuator to be uninstalled when the parking brake is in the arrested state, also by virtue of the fact that there is no electrical connection between the actuator and the electromechanical service brake. Damage to the force sensor arrangement, which would equate to a total loss, therefore does not occur during the mechanical transfer into the opened state of the parking brake.

In one exemplary arrangement, the blocking element is a pawl that engages into a toothing of the transmission. For example, the pawl has a pivot bearing end and a tooth that engages into the toothing. Additionally, the pawl may have an opening, in particular a slot, by which the blocking element is connected to the electromagnetic actuator. Here, a pin connected to the actuator plunger can engage into the opening such that a slotted guide is formed, whereby the blocking element is pivotable from an opened state into the arrested state and from the arrested state into the opened state.

An unlocking tool for manually transferring a blocking element of an electrical parking brake as described above from the arrested state into the opened state is also disclosed. In one exemplary arrangement, the unlocking tool is rod-shaped and has an insertion portion and a holding portion. The insertion portion comprises at least one axially running guide rib and/or at least one axially running guide groove.

The unlocking tool may be a special tool, that is to say a tool which is not defined in standards and which is therefore not commercially available in hardware stores or in the tool trade.

In one exemplary arrangement, if multiple guide ribs and/or guide grooves are provided, the guide ribs and/or guide grooves are arranged asymmetrically with respect to the longitudinal central axis of the unlocking tool on the circumference thereof. In this way, one circumferential orientation of the unlocking tool is ensured. In other words, if the unlocking tool has two guide ribs or guide grooves, for example, then the angular separation is not equal to 180 degrees. Owing to this circumferential orientation, it can be ensured that the unlocking tool is inserted correctly.

In one exemplary arrangement, the unlocking tool has a laterally protruding end stop that separates the insertion portion from the holding portion. Here, the end stop limits the insertion of the unlocking tool into the electrical parking brake. The end stop thus also serves for signalling to a person that the locking element has been fully released. This is the case when the end stop lies against the electromagnetic actuator. The end stop thus indicates exactly when the motor shaft has been unlocked.

The insertion portion of the unlocking tool may be of fork-shaped design and/or tapers in a wedge shape. With a fork-shaped insertion portion, the unlocking tool can engage around the actuator plunger, whereby the two are locked together, as a result of which the force can always be exactly introduced. Due to a wedge-shaped taper of the insertion portion, the unlocking tool can be more easily introduced between the electromagnetic actuator and the connection to the blocking element. Furthermore, due to the wedge shape, an exactly predefined spreading action can be achieved, which ensures exact pivoting of the blocking element.

An assembly that comprises an electromechanical service brake as described above and an unlocking tool according to the above description is also disclosed. Here, insertion of the unlocking tool into the cutout in the housing of the electromechanical service brake gives rise to a form fit by virtue of one or more guide grooves and/or one or more axially running guide ribs in the cutout and complementary guide ribs and/or guide grooves on the unlocking tool entering into engagement. One unique circumferential orientation of the unlocking tool is accordingly ensured. The unlocking tool is additionally introduced correctly into the housing without any angular deviations, and it is therefore ensured that the unlocking tool can actually release the parking brake.

In one exemplary arrangement of the assembly, the insertion portion of the unlocking tool is fork-shaped and tapers in a wedge shape. The unlocking tool can be inserted into the cutout as far as the end stop and in one single circumferential orientation and is configured to pivot the pawl into the opened state. Here, the fork-shaped insertion portion of the unlocking tool enters, and increases the size of, a gap between the electromagnetic actuator and the pawl. For this purpose, the fork-shaped insertion portion receives the actuator plunger such that, similarly to a wedge thrust mechanism, an axial force and an axial stroke can be imparted to the actuator plunger. Here, the unlocking tool is supported against the end side of the actuator, such that the blocking element can be pivoted radially out of engagement with the transmission counter to the acting holding forces.

A method for emergency unlocking of a parking brake is also disclosed, wherein the parking brake is integrated in an electromechanical service brake. Here, an electric motor and a transmission of the electromechanical service brake are surrounded by a housing that has a cutout, wherein a blocking element of the parking brake is, from the outside through the cutout, mechanically released from an arrested state in which the blocking element blocks the transmission. In other words, the parking brake can be unlocked in an emergency by virtue of the blocking element being mechanically released.

To release the actuator, use is made of an unlocking tool that pivots the blocking element out of engagement with the transmission. This is possible because the transmission is load-free, such that the release of the blocking element does not result in a total loss of the sensor arrangement.

The electromechanical service brake furthermore comprises a cover for covering the cutout, such that the cover must firstly be removed from the cutout before the parking brake can be released. As already mentioned, the cover serves for protecting against an ingress of dirt and moisture and for protecting against theft, because access to the blocking element and thus to the parking brake is impeded, such that only selected persons or services can gain access. An opening tool is commonly required to open the cover.

### BRIEF DESCRIPTION OF THE DRAWINGS

Further advantages and features of the disclosure will emerge from the following description and from the appended drawings, to which reference is made. In the drawings:

FIG. 1 is an exploded view of an exemplary arrangement of an electromechanical service brake according to the disclosure;

FIG. 2 is a plan view of the actuator of the service brake according to FIG. 1 with an exemplary arrangement of an unlocking tool according to the disclosure;

FIG. 3 is a cross section through the service brake in the region of the cutout and of the cover;

FIG. 4 is a cross section through the electrical service brake in an arrested state;

FIG. 5 is a perspective view of an exemplary arrangement of an electromagnetic actuator used in the service brake and a blocking element;

FIGS. 6A and 6B are perspective views of an exemplary arrangement of an unlocking tool according to the disclosure;

FIG. 7 shows a cross section through the actuator in an arrested state with the unlocking tool; and

FIG. 8 shows a cross section through the actuator in its opened state with the unlocking tool.

### DETAILED DESCRIPTION

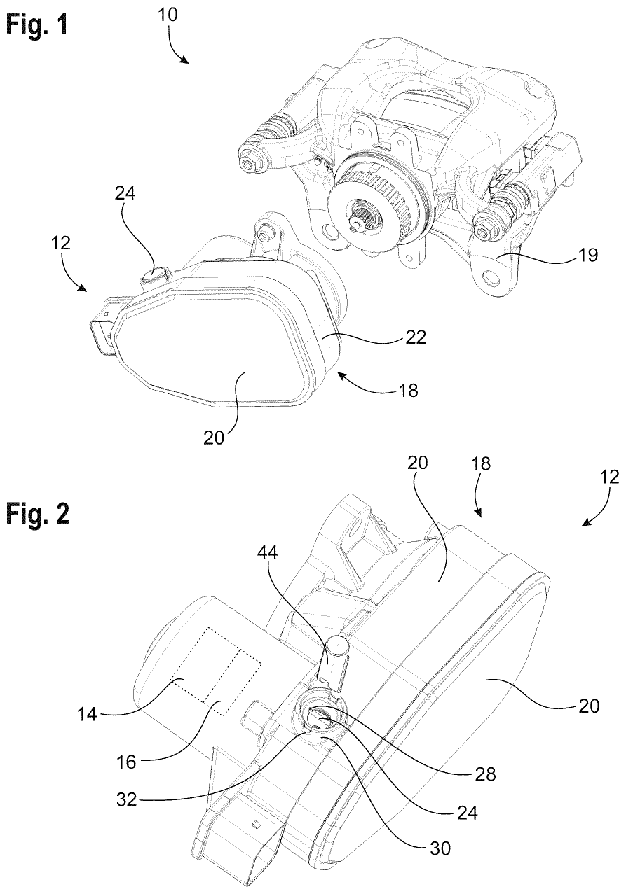

FIG. 1 shows an exemplary arrangement of an electromechanical service brake 10 which has an integrated electrical parking brake 12. Here, the parking brake 12 and an electric motor 14 and a control unit 16 are surrounded by a housing 18. The housing 18 can also be seen in FIG. 2.

The housing 18 is screwed to a carrier 19, which is to be fastened to the vehicle, of the electromechanical service brake 10 and comprises an end wall 20 and a side wall 22. The end wall 20 and the side wall 22 have a connection to one another that cannot be non-destructively released. This means that the end wall 20 cannot simply be separated from the side wall 22 without damage being caused to the parking brake 12 or to at least the housing 18 thereof.

Additionally, a circuit board, that is not shown in the figures, is attached directly under the end wall 20, such that frontal access to the electrical parking brake 12 and the mechanism thereof is not possible.

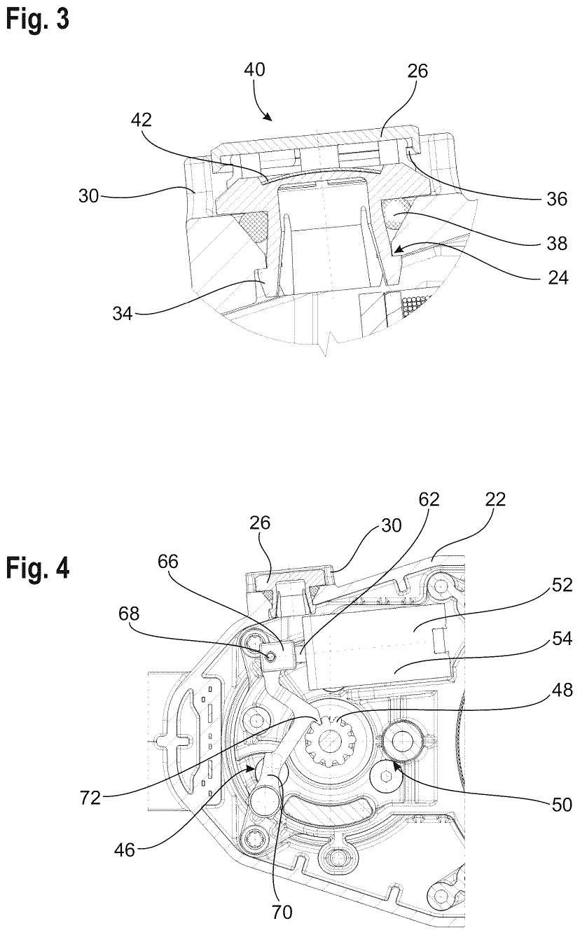

The side wall 22 furthermore has a cutout 24 that is covered by a cover 26. FIG. 2 shows the cutout 24 without the cover 26, and FIG. 3 shows a cross section through the cutout 24 with the cover 26. The cutout 24 is provided for allowing manual access to a blocking element of the parking brake if electrical actuation thereof is not possible, as will be discussed in more detail further below.

The cutout 24 is a non-circular formation that has at least one axially running guide groove 28. In the exemplary arrangement shown in the figures, the cutout 24 has two guide grooves 28 (see FIG. 2). As an alternative to guide grooves 28, the cutout 24 may also have at least one axially running guide rib.

The cutout 24 tapers conically towards the housing interior and is surrounded by a sleeve-like projection 30 which is formed integrally on the housing 18 and which protrudes outwards. The projection 30 has at least one slot 32.

The cutout 24 is covered by the cover 26. In the exemplary arrangement shown, the cover is a mushroom-shaped cover, which can also be referred to as a “plug”. Owing to its mushroom-shaped form, the cover 26 closes the cutout 24 and projects into the conical portion of the cutout 24, more specifically beyond said conical portion.

The cover 26 has detent hooks 34 that engage behind the narrowest point of the cutout 24. It is thus ensured that the cover 26 does not inadvertently become detached. For the purposes of removing the cover 26, the cover 26 has, on the edge of the mushroom head, at least one indentation 36 into which an opening tool, for example a special tool or a flat-headed screwdriver, which is inserted through the slots 32, can engage.

A seal element 38 is provided between the housing 18 and the cover 26. In one exemplary arrangement, the seal element 38 includes an elastomer and is, for example, an O-ring. In order to prevent the ingress of dirt and/or moisture, the seal element 38 is clamped between the conical region of the cutout 24 and the cover 26.

The cover 26 illustrated in FIG. 3 is additionally a pressure-equalizing element 40 between the interior of the housing 18 and the surroundings. For this purpose, a diaphragm 42 is integrated into the cover 26. The diaphragm 42 may include an expanded polytetrafluoroethylene, which has a microporous structure and hydrophobic and/or oleophobic properties. The diaphragm 42 thus allows an exchange of air and pressure between the interior of the housing 18 and the surroundings but prevents an ingress of liquids and dirt.

Also shown in FIG. 2 is an unlocking tool 44 that is introduced into the cutout 24 in order to transfer the parking brake 12 into the opened state.

The unlocking tool 44 will be described in more detail after the description of the electrical parking brake 12. The unlocking tool 44 is however generally a special tool that is available exclusively to breakdown services, towing services and workshops. This is intended to ensure that not anyone can transfer the parking brake 12 from the arrested state into the opened state and, amongst other things, protects against theft.

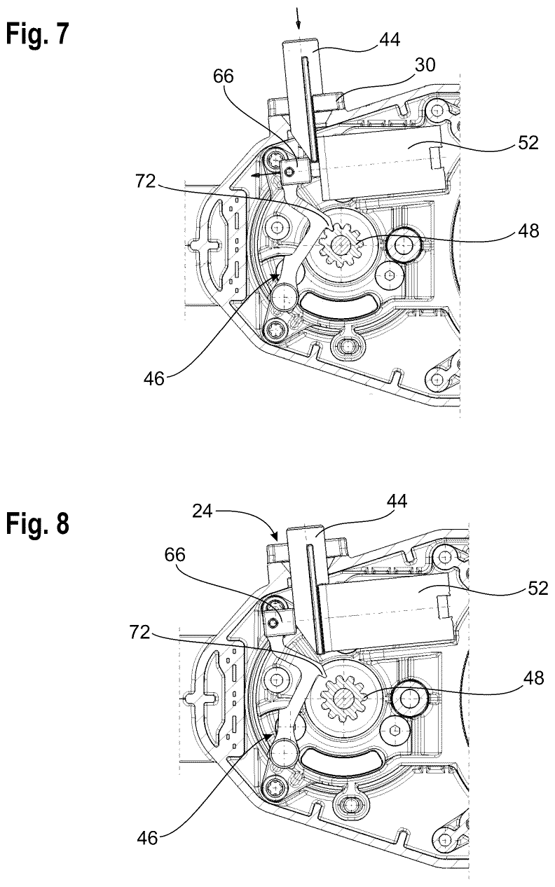

FIG. 4 and FIGS. 7 and 8 show the housing 18 without the end wall 20, such that the mechanism of the parking brake 12 is visible. For example, the parking brake 12 comprises a single-armed lever that forms a blocking element 46; in the closed state, said blocking element engages into a toothing 48 of the transmission 50 of the electromechanical service brake 10 and thus blocks the electromechanical service brake 10 in an effective manner. This arrested state of the electrical parking brake 12 can be seen both in FIG. 4 and in FIG. 7.

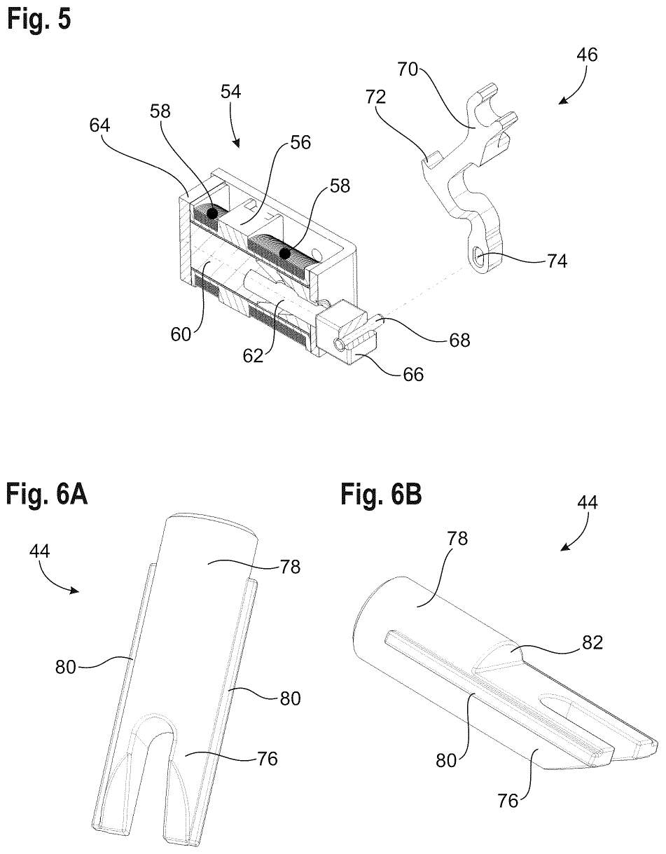

The blocking element 46 is moved into the arrested state and into the opened state by an electromagnetic actuator 52. The electromagnetic actuator 52 may be a bistable solenoid 54 as shown in cross section in FIG. 5.

The solenoid 54 comprises two permanent magnets 56 and two series-connected coils 58. An armature 60 and an actuator plunger 62 are arranged within the coils 58 and the permanent magnet 56.

Only the actuator plunger 62 projects out of an actuator housing 64; said actuator plunger is connected to a head 66, in which a pin 68 is supported.

The pin 68 provides the connection to the blocking element 46, wherein the blocking element 46 shown here is a pawl. The pawl has a pivot bearing end 70 and a tooth 72 that engages into the toothing 48 of the transmission 50.

The pawl furthermore has an opening 74 in a region which is remote from the tooth 72 and which, compared to the tooth 72, is situated further away from the pivot bearing end 70. The opening 74 is preferably a slot into which the pin 68 of the electromagnetic actuator 52 engages, such that a slotted guide is formed. In the arrested state, the cutout 24 is arranged symmetrically over the head 66 of the actuator plunger 62, such that the cutout 24 is oriented orthogonally with respect to the armature 60 and a motor shaft.

In the event of a fault of the parking brake 12, the cutout 24 allows the blocking element 46 to be manually actuated from the outside in order to transfer the parking brake 12 into the opened state. Such a fault may be caused for example by a defective solenoid, a defective electric motor 14, a defective control unit 16 or an electrical failure.

The problem in the event of such a fault in the electronics lies in the residual clamping forces that arise in the blocked state of the parking brake 12. These residual clamping forces may lie in the kilonewton range and thus render onward travel impossible. Since the transmission 50 is however load-free, the residual clamping forces can be mechanically reduced from the outside without the force sensor arrangement being damaged in the process. A total loss is thus prevented, and onward travel is made possible relatively quickly.

To transfer the parking brake 12 into the opened state, it is thus necessary for a tension force to be built up by the electromechanical service brake 10, which is no longer possible in the event of such a defect.

For the purposes of manually transferring the parking brake 12 into the opened state in the event of an electrical fault, an exemplary unlocking tool 44 as shown in FIGS. 6A and 6B is provided.

In one exemplary arrangement, the unlocking tool 44 is a rod-shaped special tool. This means that the unlocking tool 44 is not defined by standards and therefore cannot be purchased in hardware stores or in the tool trade. It can thus be ensured that the parking brake 12 can be released only by selected persons or services.

The unlocking tool 44 (see FIGS. 6A and 6B) has an insertion portion 76 and a holding portion 78. Here, the insertion portion 76 comprises at least one axially running guide rib 80 which forms the counterpart to the at least one guide groove 28 of the cutout 24. Alternatively, the insertion portion 76 may also comprise at least one axially running guide groove.

Analogously to the guide grooves 28, the guide ribs 80 are also arranged asymmetrically with respect to the longitudinal central axis of the unlocking tool 44 on the circumference of said unlocking tool. In this way, one circumferential orientation of the unlocking tool 44 is ensured.

In the exemplary arrangement of the unlocking tool 44 shown in FIGS. 6A and 6B, two guide ribs 80 are provided, the angular separation of which is not equal to 180 degrees.

Additionally, the insertion portion 76 of the unlocking tool 44 is of fork-shaped design. As can be seen in FIG. 6B, the fork-shaped insertion portion 76 tapers in a wedge shape on one side, whilst being planar on the other side. An end stop 82 is thus formed, which protrudes laterally and separates the insertion portion 76 from the holding portion 78.

If it is necessary for the parking brake 12 to be manually transferred into the opened state owing to an electrical defect of the electromechanical service brake 10, the cover 26 of the cutout 24 is firstly removed. For this purpose, an opening tool is inserted into the slot 32 of the projection 30 such that the opening tool can engage into the indentation 36 of the cover 26, such that the cover 26 can be removed.

The unlocking tool 44 is subsequently introduced through the cutout 24 into the interior of the housing 18. This gives rise to a form fit between the unlocking tool 44 and the cutout 24 in the housing 18 of the electromechanical service brake 10, because the guide grooves 28 of the cutout 24 and the complementary guide ribs 80 on the unlocking tool 44 enter into engagement. One unique circumferential orientation of the unlocking tool 44 is thus provided, and it is ensured that the unlocking tool 44 is inserted at the correct angle into the housing 18. This can be seen in FIG. 7.

Here, the fork-shaped insertion portion 76, which tapers in a wedge shape, of the unlocking tool 44 enters a gap between the electromagnetic actuator 52 and the head 66, such that the fork-shaped insertion portion 76 receives the actuator plunger 62. Owing to the wedge-shaped insertion portion 76, an axial force and an axial stroke are imparted to the actuator plunger 62 as a result of the unlocking tool 44 being pushed in, similarly to a wedge thrust mechanism. Accordingly, the actuator plunger 62 is moved counter to the stroke-imparting force, whereby the tooth 72 of the blocking element 46 is pivoted out of engagement with the toothing 48 of the transmission 50.

The unlocking tool 44 is pushed into the housing 18 of the electromechanical service brake 10 until the end stop 82 is supported against the end side of the electromagnetic actuator 52. At this point in time, the engagement of the blocking element 46 is fully released, and the rotational movement of the transmission 50 is enabled again, as shown in FIG. 8.

In another exemplary arrangement, which is not shown in the figures, the cover 26 may also be screwed to the housing 18 of the electromechanical service brake 10. In this case, in particular, the cutout 24 has a thread. In the case of such a screw fastening, neither the indentations 36 and the detent hooks 34 of the cover 26 nor the slots 32 in the projection 30 are required. Furthermore, an opening tool is not imperatively required to open the cover 26, because this can simply be unscrewed.

The cover 26 may alternatively also be equipped with a security lock in order to ensure a certain degree of protection against incidental and unauthorized opening. Accordingly, an opening tool, which may in principle be a special tool, is again required to open the cover 26. The security lock may for example involve a coding as in the case of a locking wheel bolt or nut. Alternatively, the cover 26 may also be designed such that it can be released only using a key, for example the vehicle key, similarly to a fuel-tank lock.

1. An electromechanical service brake having an integrated electrical parking brake, comprising; an electric motor and a control unit, wherein the parking brake comprises a blocking element which, in an arrested state of the parking brake, mechanically blocks a transmission of the electromechanical service brake, wherein the electric motor and the transmission are surrounded by a housing which has a cutout which allows the blocking element to be manually actuated from the outside, such that the blocking element can, from the outside, be mechanically transferred from the arrested state into an opened state, wherein, in the opened state, the transmission is freely movable, and wherein the cutout is a non-circular formation that has at least one axially running guide groove and/or at least one axially running guide rib.

2. The electromechanical service brake according to claim 1, wherein the cutout conically tapers and is surrounded by a sleeve-like projection which is formed integrally on the housing and which protrudes outwards.

3. The electromechanical service brake according to claim 1, wherein the cutout is covered by a cover, which is received in the cutout and in the projection, wherein an opening tool is required to remove the cover, and wherein the projection has at least one slot by which the opening tool can engage laterally on the cover to remove same.

4. The electromechanical service brake according to claim 3, wherein the cover is a pressure-equalizing element between an interior of the housing and surroundings, wherein a diaphragm is integrated into the cover.

5. The electromechanical service brake according to claim 3, wherein the cover has detent hooks which engage behind a narrowest point of the cutout.

6. The electromechanical service brake according to claim 1, wherein an electromagnetic actuator is provided for moving the blocking element into the arrested state and the opened state.

7. The electromechanical service brake according to claim 1, wherein the blocking element is a pawl, wherein the pawl engages into a toothing of the transmission.

8. An unlocking tool for manually transferring a blocking element of an electrical parking brake according to claim 1 from the arrested state into the opened state, wherein the unlocking tool is rod-shaped and has an insertion portion and a holding portion, wherein the insertion portion comprises at least one axially running guide rib and/or at least one axially running guide groove.

9. The unlocking tool according to claim 8, wherein, if multiple guide ribs and/or guide grooves are provided, the guide ribs and/or guide grooves are arranged on the circumference asymmetrically with respect to the longitudinal central axis of the unlocking tool, such that one circumferential orientation of the unlocking tool is ensured.

10. The unlocking tool according to claim 8, wherein the unlocking tool has a laterally protruding end stop that separates the insertion portion from the holding portion, wherein the end stop limits the insertion of the unlocking tool into the electrical parking brake (12).

11. The unlocking tool according to claim 8, wherein the insertion portion of the unlocking tool is of a fork-shaped design and/or tapers into a wedge shape.

12. An assembly comprising an electromechanical service brake according to claim 1 and an unlocking tool, for manually transferring a blocking element of the electrical parking brake from the arrested state into the opened state, wherein the unlocking tool is rod-shaped and has an insertion portion and a holding portion, wherein the insertion portion comprises at least one axially running guide rib and/or at least one axially running guide groove, wherein insertion of the unlocking tool into the cutout in the housing of the electromechanical service brake gives rise to a form fit by virtue of one or more guide grooves and/or one or more axially running guide ribs in the cutout and complementary guide ribs or guide grooves on the unlocking tool entering into engagement, resulting in a single unique circumferential orientation of the unlocking tool.

13. The assembly according to claim 12, wherein the insertion portion of the unlocking tool is of fork-shaped design and tapers in a wedge shape, wherein the unlocking tool can be inserted into the cutout as far as the end stop and in one single circumferential orientation and is configured to pivot the pawl into the opened state, wherein the fork-shaped insertion portion of the unlocking tool enters, and increases the size of, a gap between the electromagnetic actuator and the pawl.

14. The electromechanical service brake according to claim 2, wherein the cutout is covered by a cover, which is received in the cutout and in the projection, wherein an opening tool is required to remove the cover, and wherein the projection has at least one slot by which the opening tool can engage laterally on the cover to remove same.

15. The electromechanical service brake according to claim 2, wherein the cover is a mushroom shaped.

16. The electromechanical service brake according to claim 4, wherein the cover has detent hooks which engage behind a narrowest point of the cutout.

17. The electromechanical service brake according to claim 7, wherein the pawl has a pivot bearing end and has a tooth which engages into the toothing.
